(19) United States
(12) Patent Application Publication
(10) Pub. No.: US 2009/0057362 A1
(43) Pub. Date: Mar. 5, 2009

(54) APPARATUS AND METHOD FOR WEBBING-UP A PRINTING SUBSTRATE WEB OR A PARTIAL WEB IN A WEB-FED ROTARY PRINTING PRESS

(75) Inventor: Stefan MENZINGER, Dasing (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/199,210

(22) Filed: Aug. 27, 2008

(30) Foreign Application Priority Data
Aug. 30, 2007 (DE) 10 2007 040 969.0

(51) Int. Cl. B41F 13/03; B65H 20/16; B65H 23/028

(52) U.S. Cl. 226/2; 226/92; 101/228

(57) ABSTRACT

An apparatus and method for webbing-up a printing substrate web or a partial web in the regions of a web-fed rotary printing press without an automatic webbing-up device, is disclosed. A webbing-up aid includes a threading tip for manually threading the webbing-up aid along a web path being webbed-up, a clamping piece for clamping one end of the printing substrate web or partial web being webbed-up, and a cable-like connecting element positioned between the threading tip and the clamping piece. The clamping piece includes two magnetic clamping sections that can be pivoted relative to each other, between which the end of the printing substrate web or the partial web being webbed-up can be clamped. The threading tip is also embodied to be magnetic so that when the webbing-up aid is being threaded, the threading tip can be can be placed on metallic or metallized web guide elements.

This application claims the priority of German Patent Document No. 10 2007 040 969.0, filed Aug. 30, 2007, the disclosure of which is expressly incorporated by reference herein.

### BACKGROUND AND SUMMARY OF THE INVENTION

The invention relates to an apparatus and method for webbing-up a printing substrate web or a partial web in, for example, a turner bar nest and/or folder superstructure of a web-fed rotary printing press, in particular manually.

Webbing-up a printing substrate web in a web-fed rotary printing press by means of an automatic webbing-up device is already known from the prior art. In this regard, reference is made to “Handbuch der Printmedien” [Handbook of Print Media], Helmut Kipphan, Page 278, Springer Verlag [Springer Publishers], Year 2000. The webbing-up device known from the prior art can web-up an unturned and undivided printing substrate web starting from a reel changer up to a former of the web-fed rotary printing press. The webbing-up devices known from the prior art are not suitable for webbing-up turned printing substrate webs or partial webs of the webbed-up web, e.g., through the turner bar nest and folder superstructure, and thus, for conveying them to a former. As a result, there is a need for a simple, universally usable and cost-effective webbing-up aid and method which can be used to web-up a printing substrate web or partial web in all regions such as, for example, a turner bar nest and/or folder superstructure of a web-fed rotary printing press, in which an automatic webbing-up device is not available.

Starting herefrom, the present invention is based on the objective of creating a novel, simple, universally usable and cost-effective webbing-up aid and method for webbing-up a printing substrate web or partial web, for example, in a turner bar nest and/or folder superstructure, of a web-fed rotary printing press.

The inventive webbing-up aid and method includes a threading tip for manually threading the webbing-up aid along a web path being webbed-up, e.g., in the turner bar nest and/or folder superstructure, a clamping piece for clamping one end of the printing substrate web or partial web being webbed-up, and a cable-like connecting element positioned between the threading tip and the clamping piece, wherein the clamping piece is comprised of two magnetic clamping sections that can be pivoted relative to each other, between which the end of the printing substrate web or the partial web being webbed-up can be clamped, and wherein the threading tip is also embodied to be magnetic so that when the webbing-up aid is being threaded, for example, in the turner bar nest and/or folder superstructure, the threading tip can be can be placed on metallic or metallized web guide elements.

The inventive webbing-up aid is used for webbing-up a printing substrate web or partial web, e.g., in a turner bar nest and/or folder superstructure of a web-fed rotary printing press, such as, for example, a newspaper printing press. The webbing-up device can be threaded easily, e.g., in the turner bar nest and/or folder superstructure, using the threading tip, which is embodied to be magnetic, wherein in this case, the webbing-up aid can be placed by a printer at hard-to-access locations on metallic or metallized web guide elements without the risk of the threading tip falling off and necessitating that the threading process be re-started. The printing substrate web or partial web being webbed-up can be clamped between two magnetic clamping sections of a clamping piece. A cable-like connecting element runs between the clamping piece and the threading tip. The web path being webbed-up manually can already be prepared with the webbing-up aid before production is started.

Preferred developments of the invention are yielded from the following description. Exemplary embodiments of the invention are explained on the basis of the drawings.

### BRIEF DESCRIPTION OF THE DRAWINGS

FIG. 1 is a schematic representation of an inventive webbing-up aid;

FIG. 2 illustrates the inventive webbing-up aid from FIG. 1 together with a partial web and web guide elements; and

FIGS. 3a to 3d illustrate a progression of steps in the use of the inventive webbing-up aid.

### DETAILED DESCRIPTION OF THE DRAWINGS

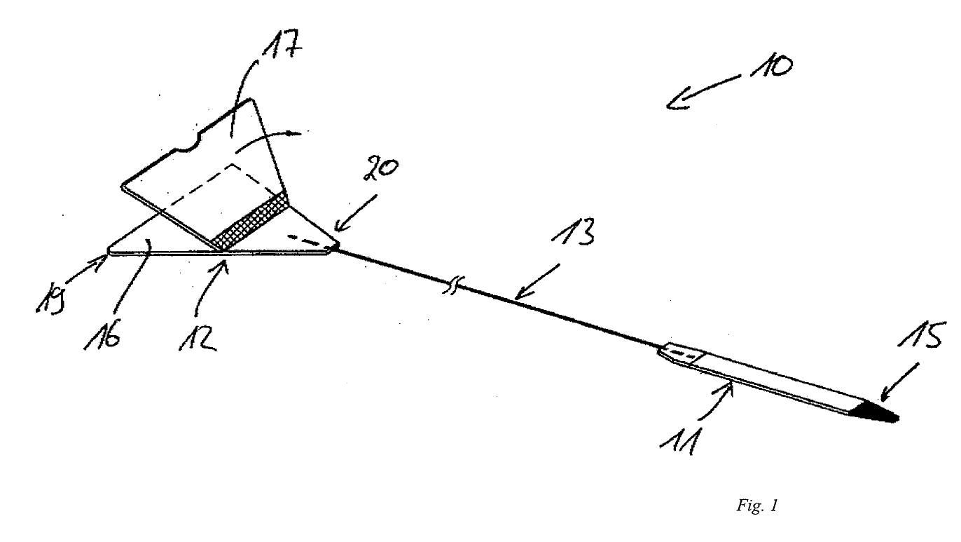

FIG. 1 shows a schematic representation of an inventive webbing-up aid 10 for webbing-up a printing substrate web or partial web, for example, in a turner bar nest and/or folder superstructure of a web-fed rotary printing press, wherein the inventive webbing-up aid 10 has a threading tip 11, a clamping piece 12, as well as a cable-like connecting element 13 positioned between the threading tip 11 and the clamping piece 12.

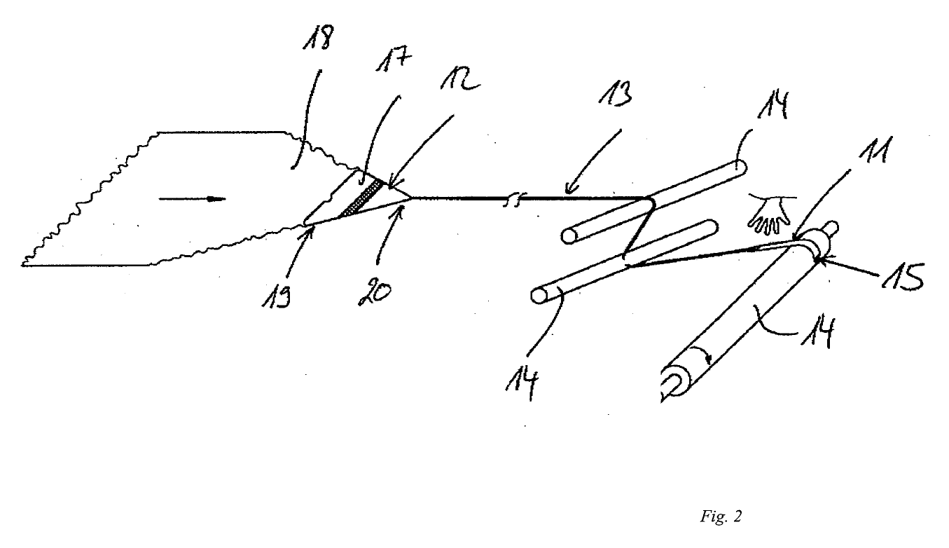

The threading tip 11 of the inventive webbing-up aid 10 is used for manually threading the webbing-up aid 10, for example, in the turner bar nest and/or folder superstructure. The threading tip 11 is embodied to be magnetic, and namely made of a magnetic film, wherein the magnetically embodied threading tip can be placed during threading of the same, for example, in the turner bar nest or folder superstructure of a web-fed rotary printing press according to FIG. 2, on metallic or metallized web guide elements 14. As a result, the threading tip 11 can be placed by a printer during the threading process in areas that are hard to access without the risk that the threading tip can fall out.

The threading tip 11 of the inventive webbing-up aid 10 is preferably embodied exclusively on one side to be magnetic, wherein at least on one side in the region of a tip 15 of the same is designed to be non-magnetic. This guarantees that a threading tip 11 placed on a web guide element 14 can be easily grasped and easily removed from the web guide element 14.

The clamping piece 12 of the inventive webbing-up aid 10 that is opposite from the threading tip 11 is formed of two magnetic clamping sections 16, 17, which can be pivoted relative to each other, wherein one end of a printing substrate web or partial web 18 (see FIG. 2) being webbed-up can be clamped between the two magnetic clamping sections 16, 17. Just like the threading tip 11, the magnetic clamping sections 16, 17 of the clamping piece 12 are also preferably made of a magnetic film. The upper and lower parts of the clamping sections 16, 17 preferably do not have the same shape and/or size in order to make opening up the clamping sections 16, 17 easier. The thickness of the magnetic films is between 0.2 mm and 2.0 mm. In particular, the thickness of the magnetic film is approximately 0.5 mm.

The connecting element 13 running between the threading tip 11 and the clamping piece 12 is embodied to be cable-like, preferably as a plaited, elastic, flexible connecting cable with a length between 5 m and 20 m. The length of the connecting cable 13 depends of course on the length of the path through the regions of a web-fed rotary printing press through which a printing substrate web or partial web must be webbed-up or threaded.

According to FIGS. 1 and 2, the clamping piece 12 has a trapezoidal contour, namely such that the clamping piece tapers from a rear section 19 in the direction of a forward section 20 on which the cable-like connecting element 13 engages.

As a result, the inventive webbing-up aid is comprised of a magnetic threading tip 11, an elastic, cable-like connecting element 13, and a magnetic clamping piece 12 that can be opened up. When transferring and winding around web guide elements, a magnetic side of the threading tip 12 can be placed on the web guide element so that the same adheres to the web guide element and cannot slip away. It is possible for it to grip the web guide elements securely.

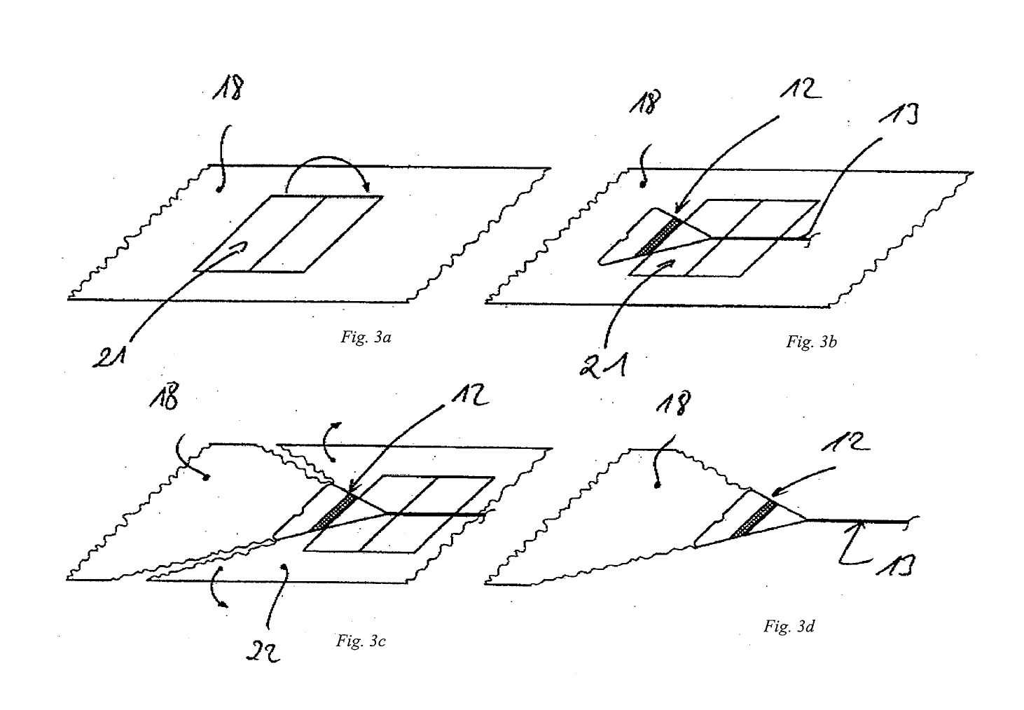

The procedure depicted in FIGS. 3a through 3d is used to web-up a printing substrate web or partial web with the inventive webbing-up aid in regions without automatic webbing-up devices, e.g., in the turner bar nest and/or folder superstructure of a web-fed rotary printing press. First of all, a window or a pocket 21 is cut into a to-be-webbed-up printing substrate web 18 according to FIG. 3a. The clamping piece 12 of the inventive webbing-up aid 10 is threaded through the opened pocket or the opened window, wherein the printing substrate web 18 is clamped on the clamping piece 12 of the inventive webbing-up aid 10 with a section adjacent to the window 21 (see FIG. 3b). Then according to FIG. 3c, the part 22 of the printing substrate web 18 is separated, which would be located in front of the clamping piece 12 of the inventive webbing-up aid 10 during webbing up of the printing substrate web, e.g., in the turner bar nest and/or folder superstructure. This results in the configuration depicted in FIG. 3d, in which the printing substrate web 18 is then webbed-up by means of the inventive webbing-up aid 10, e.g., in the turner bar nest and/or folder superstructure of a web-fed rotary printing press.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A webbing-up aid for webbing-up a printing substrate web or a partial web in a region of a web-fed rotary printing press without an automatic webbing-up device, comprising a threading tip for manually threading the webbing-up aid along a web path being webbed-up, a clamping piece for clamping an end of the printing substrate web or the partial web being webbed-up, and a cable-like connecting element positioned between the threading tip and the clamping piece, wherein the clamping piece is comprised of two magnetic clamping sections that are pivotable relative to each other, between which the end of the printing substrate web or the partial web being webbed-up is clampable, and wherein the threading tip is magnetic such that when the webbing-up aid is being threaded the threading tip is placed on metallic or metallized web guide elements.

2. The webbing-up aid according to claim 1, wherein the region is in a turner bar nest and/or a folder superstructure.

3. The webbing-up aid according to claim 1, wherein the magnetic clamping sections of the clamping piece are made of a magnetic film.

4. The webbing-up aid according to claim 1, wherein the magnetic threading tip is made of a magnetic film.

5. The webbing-up aid according to claim 3, wherein the magnetic film has a thickness between 0.2 mm and 2.0 mm.

6. The webbing-up aid according to claim 1, wherein the cable-like connecting element is an elastic, flexible connecting cable.

7. The webbing-up aid according to claim 1, wherein a maximum length of the cable-like connecting element is as long as a web path to be manually webbed-up.

8. The webbing-up aid according to claim 1, wherein the threading tip is not magnetic on one side at least on a forward section of the threading tip.

9. The webbing-up aid according to claim 1, wherein the clamping piece has a trapezoidal contour such that the clamping piece tapers from a rear section in a direction of a forward section on which the cable-like connecting element engages.

10. The webbing-up aid according to claim 1, wherein the clamping sections have different shapes and/or sizes.

11. A method for webbing-up a printing substrate web in a web-fed rotary printing press, comprising the steps of:
clamping an end of the printing substrate web between two clamping sections of a clamping piece;
placing a threading tip on a web guide element;
wherein a connecting element couples the clamping piece to the threading tip; and
webbing-up the substrate web by winding the web guide element with the threading tip placed on the web guide element.

12. The method according to claim 11, further comprising the steps of:
cutting an opening in the printing substrate web; and
threading the clamping piece through the opening;
wherein the end of the printing substrate web clamped to the clamping piece is adjacent to the opening.

13. The method according to claim 12, further comprising the step of removing a portion of the printing substrate web that is disposed in front of the clamping piece after the printing substrate web is clamped to the clamping piece.

14. The method according to claim 11, wherein the clamping sections are magnetic and wherein the end of the printing substrate web is clamped between the two magnetic clamping sections.

15. The method according to claim 11, wherein the threading tip is magnetic and wherein the step of placing the threading tip on the web guide element includes the step of magnetically attaching the threading tip to the web guide element.

16. The method according to claim 11, wherein the connecting element is a flexible cable.

17. The method according to claim 11, wherein the clamping piece has a trapezoidal contour.

18. The method according to claim 11, wherein the clamping sections are pivotable with respect to each other.

19. The method according to claim 11, wherein the two clamping sections have different configurations.

20. The method according to claim 11, wherein the printing substrate web is a partial web.
